(19) United States
(12) Patent Application Publication
(10) Pub. No.: US 2011/0108133 A1
(43) Pub. Date: May 12, 2011

(54) INFLATION NOZZLE OF TIRE PUMP HAVING AIR SEALING FUNCTION

(76) Inventors: Ying-Che HUANG, Changhua County (TW); Chun-Ming Huang, Changhua County (TW)

(21) Appl. No.: 12/615,150

(22) Filed: Nov. 9, 2009

(51) Int. Cl. F16K 15/02

(52) U.S. Cl. 137/223

(57) ABSTRACT

An inflation nozzle of a tire pump having air sealing function includes a casing, a valve plug seat, a valve plug and a locking ring. The valve plug seat includes a head portion at one end and a groove defined annularly on an outer periphery thereof. A sealing ring is engaged with the groove. The sealing ring protrudes radially beyond the head portion so as to be in contact with an inner circular periphery of the casing when the valve plug is installed in the valve plug seat and the casing is connected with a locking ring. The sealing ring ensures that no leakage between the valve plug seat and the casing.

### BACKGROUND OF THE INVENTION

1. Field of the Invention

The present invention relates generally to an inflation nozzle of a tire pump having air sealing function, and in particular to an inflation nozzle of a tire pump rotatable to screw connect with a valve of a tire.

2. The Prior Arts

Taiwan Patent No. I307388 discloses an inflation nozzle for a tire pump that is invented by the present inventors and includes a machined or integrally formed valve plug seat. The valve plug seat includes a head portion at one end and the head portion has an enlarged exterior diameter. The head portion has an inner space to receive a valve plug and a core member. The wall of the head portion is located between a casing and the valve plug, which prevent the rubber valve plug from contacting with the metal casing during rotation. Thus, the rotation of the casing would not be hindered. Another feature for the conventional inflation nozzle for the tire pump is that the core member includes multiple outlets which are in communication with a passage in the valve plug seat after the valve plug and the core member are installed in the head portion. A flange of the core member is engaged with a groove in the valve plug, thereby connecting the core member with the valve plug. The valve plug and the core member are then installed in the interior of the valve plug seat which is installed in the casing. A locking ring is mounted to the casing to keep the valve plug seat in the casing.

The core member and the valve plug seat are designed to be separated parts which simplifies the manufacturing processes, reduces the manufacturing cost and makes the assembly easier. There are multiple outlets in the outside of a central rod of the core member and the central rod contacts against a needle of a tire valve and the pressurized air goes out from the outlets. The arrangement can provide significant amount of pressurized air within a short period of time.

Because the core member and the valve plug seat are separated, the core member, the valve plug seat and the casing having the threaded hole can be replaced according to the types of the tire valves, such as French type tire valve, American type tire valve or British type tire valve.

The inflation nozzle is connected to the valve of the tire by rotating screw connection which has better sealing function compared with other conventional tire pumps. However, the sealing feature has to be enhanced when using a high pressure tire pump, such as a carbon dioxide high pressure tire pump. The high pressure can be easily released when the inflation nozzle is connecting with or disengaging from the valve of the tire. The greater the pressure, the more pressure is released. Thus, the efficiency of the tire pump is reduced. Therefore, an inflation nozzle with high level of sealing function is needed for the tire pumps with high pressure.

### SUMMARY OF THE INVENTION

A primary objective of the present invention is to provide an inflation nozzle of a tire pump having air sealing function that overcomes the disadvantages of the conventional design mentioned above. In order to achieve the objective, an inflation nozzle of a tire pump having air sealing function according to the present invention includes a casing, a valve plug seat, a valve plug and a locking ring. The valve plug seat includes a head portion at one end and a groove defined annularly on an outer periphery thereof. A sealing ring is engaged with the groove. The sealing ring protrudes radially beyond the head portion so as to be in contact with the inner circular periphery of the casing when the valve plug is installed in the valve plug seat and the casing is connected with the locking ring. The sealing ring ensures that no leakage between the valve plug seat and the casing. Another main characteristic of the present invention is that the inner circular periphery of the casing extends a length which is longer than a sum of a length of the head portion of the valve plug seat and a width of the groove, such that the casing covers the groove and is connected to the locking ring. Thus, the sealing ring can provide an enhanced sealing feature.

### BRIEF DESCRIPTION OF THE DRAWINGS

The present invention will be apparent to those skilled in the art by reading the following detailed description of a preferred embodiments thereof, with reference to the attached drawings, in which:

FIG. 1 is a perspective view showing an inflation nozzle of a tire pump having air sealing function in accordance with the present invention;

FIG. 2 is an exploded view showing the inflation nozzle according to the present invention;

FIG. 3 is a cross sectional view showing the inflation nozzles according to three embodiments of the present invention that is capable of connecting with three different types of tire valves;

FIG. 4A is a cross sectional view showing the inflation nozzle according to the first embodiment of the present invention connected with a French type tire valve;

FIG. 4B is a cross sectional view showing the inflation nozzle according to the second embodiment of the present invention connected with an American type tire valve;

FIG. 4C is a cross sectional view showing the inflation nozzle according to the third embodiment of the present invention connected with a British type tire valve;

FIG. 5 is a cross sectional view showing the inflation nozzle according to the fourth embodiment of the present invention connected with a special French type tire valve;

FIG. 6 is a cross sectional view showing the connection of the inflation nozzle and the tire pump, and

FIG. 7 is a cross sectional view showing the connection of the inflation nozzle and a flexible hose according to another embodiment.

### DETAILED DESCRIPTION OF THE PREFERRED EMBODIMENT

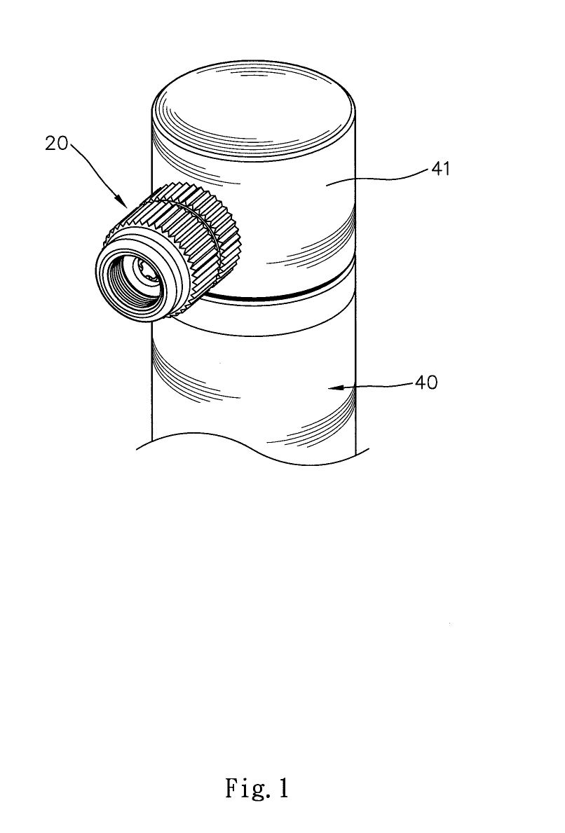

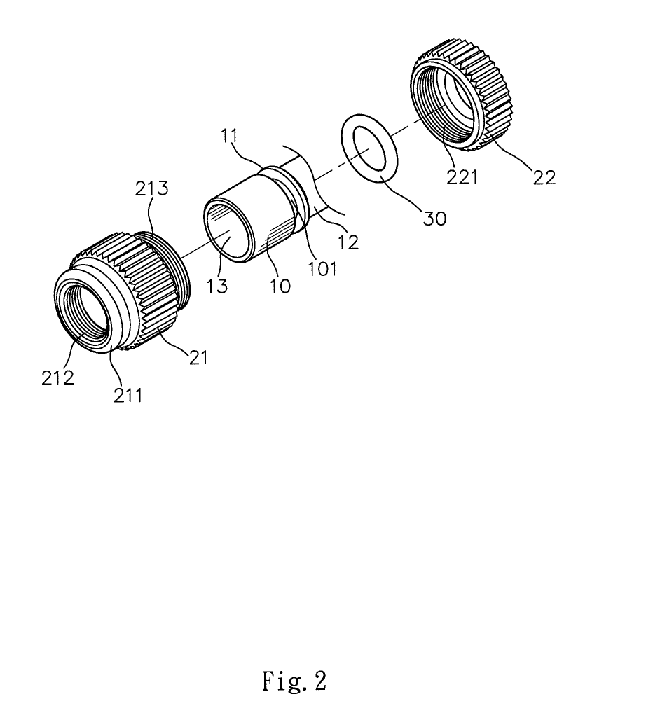

With reference to the drawings and in particular to FIGS. 1, 2 and 3, an inflation nozzle 20 of a tire pump 40 having air sealing function is mounted to a head part 41 of the tire pump 40 and includes a casing 21, a valve plug seat 10, a valve plug 31, 32 or 33 and a locking ring 22. The inflation nozzle 20 can connect with a valve of a tire to inflate the tire. The casing 21 includes an output end 211 located at a first end of the casing 21, first threads 212 defined in the first end of the casing 21 and second threads 213 defined on a second end of the casing 21. The second threads 213 are defined on an outer periphery of the casing 21. The casing 21 further includes an inner circular periphery 214. The locking ring 22 includes third threads 221 defined in an inner wall thereof and an opening 222 defined through the locking ring 22. The valve plug seat 10 includes a head portion 13 that has an inner space. The head portion 13 is inserted into the casing 21 from the second end of the casing 21 and a hose 12 is connected to the head portion 13. The second threads 213 meshes with the third threads 221 to connect the casing 21 with the locking ring 22 and the hose 12 extends through the opening 222. The head portion 13 is enclosed between the casing 21 and the locking ring 22. The casing 21 and the locking ring 22 are rotatable without rotating the head portion 13 and the hose 12.

In order to enhance the sealing feature of the assembly of the casing 21, the locking ring 22 and the head portion 13, the valve plug seat 10 further includes a groove 101 defined annularly in an outer periphery thereof and a flange 11 is formed beside the groove 101. A sealing ring 30 is engaged with the groove 101 and the flange 11 restricts the travel of the hose 12.

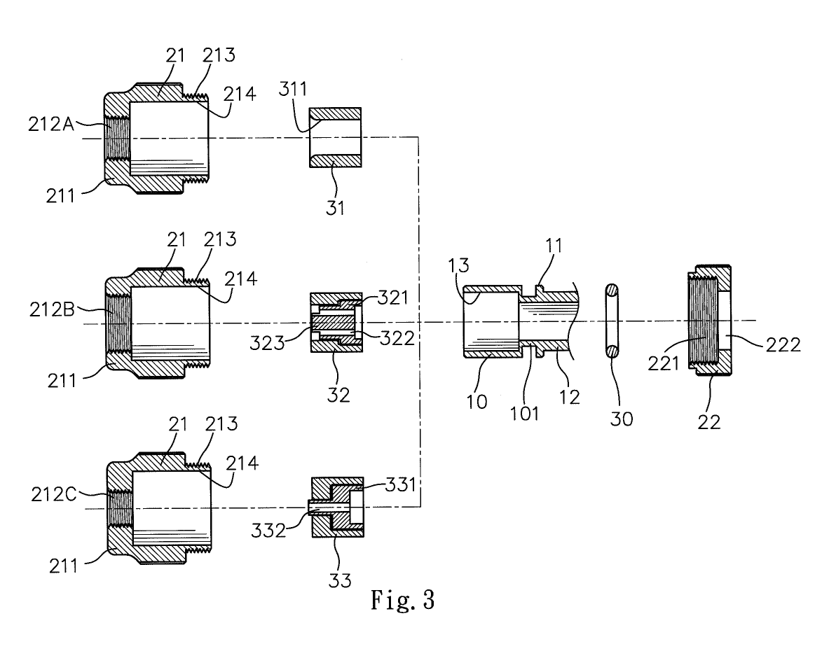

FIG. 3 shows various applications of the valve plug seat 10 of the present invention, wherein the interior of the head portion 13 can accommodate three types of valve plugs and core members. The first embodiment is connected with a French type valve plug 31 and the first threads 212A corresponding to a French type valve of a tire. The valve plug 31 is a tubular member and received in the head portion 13. The second embodiment is connected with an American type valve plug 32 and the first threads 212B corresponding to an American type valve of a tire. The American type valve plug 32 includes a core member 321 which has a passage 322 and a core piece 323. The third embodiment is connected with a British type valve plug 33 and the first threads 212C corresponding to a British type valve of a tire. The British type valve plug 33 includes a core member 331 in which a central passage 332 is defined therethrough. Both of the American type valve plug 32 and the British type valve plug 33 include the core member 321 and 331, so that the corresponding first threads 212B and 212C can match with the two different types of valve plugs without changing the locking ring 22 or the valve plug seat 10.

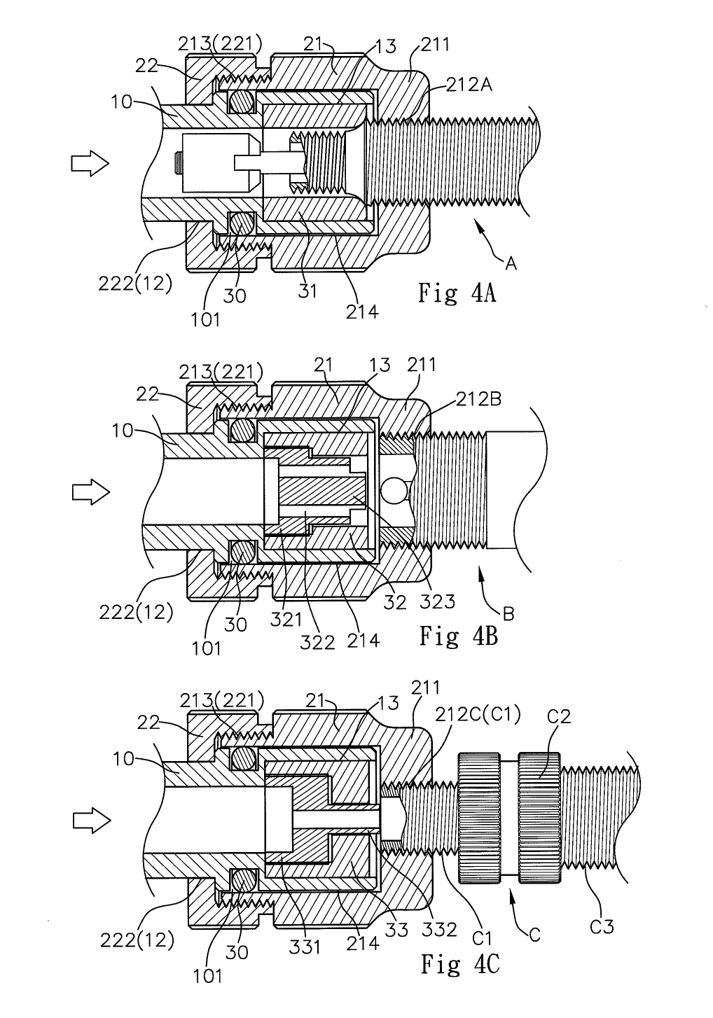

Referring to FIGS. 3 and 4, the radial width of the sealing ring 30 is slightly larger than the depth of the groove 101, wherein the depth is calculated from the outer periphery of the head portion 13 to the inner bottom of the groove 101. Thus, the sealing ring 30 is pressed against the inner circular periphery 214 of the casing 21 to form a sealing relationship. The sealing ring 30 is made of a high wear-resisting material. Because it only needs limited numbers of revolution to screw connect the casing 21 with the valve of the object to be pumped, proper lubrication can be applied to the sealing ring 30 to form a reliable sealing feature which can function normally under large pressure. The sealing ring 30 ensures no leakage between the groove 101 and the inner circular periphery 214 of the casing 21.

Referring to FIGS. 4A, 4B and 4C, when the French type valve A, the American type valve B and the British type valve are respectively connected with the corresponding first threads 212A, 212B and 212C of the casing 21, the valve plugs 31, 32 and 33 are respectively contacted with the valves A, B and C. The sealing ring 30 in the groove 101 is cooperated with the inner circular periphery 214 of the casing 21 to ensure no air leaks from the casing 21.

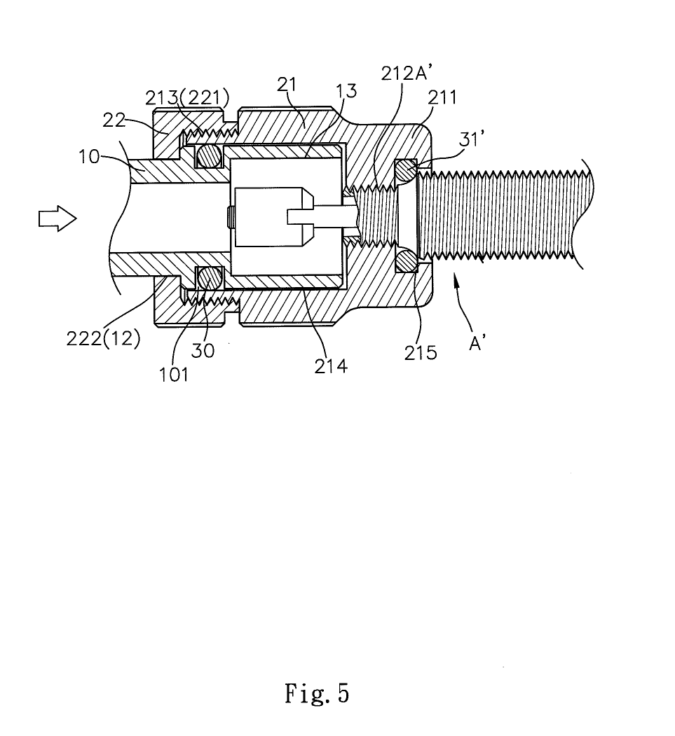

FIG. 5 shows the fourth embodiment which is a special French type valve A′ which includes a small-diameter thread at a front end thereof. The first threads 212A′ in the output end 211 of the casing 21 is made to be engaged with the small-diameter threads of the special French type valve A′. Besides, a groove 215 is defined in an inner periphery of the first end of the casing 21 and located beside the first threads 212A′. A valve plug 31′ is engaged with the groove 215 in the first end of the casing 21 and the valve plug 31′ is an O-ring. The outer periphery of the O-ring slightly protrudes out from the inner surface of the groove 215, such that the valve plug 31′ contacts with the small-diameter thread to form the sealing function. Another sealing area is the contact between the sealing ring 30 in the groove 101 and the inner circular periphery 214 to ensure no leakage.

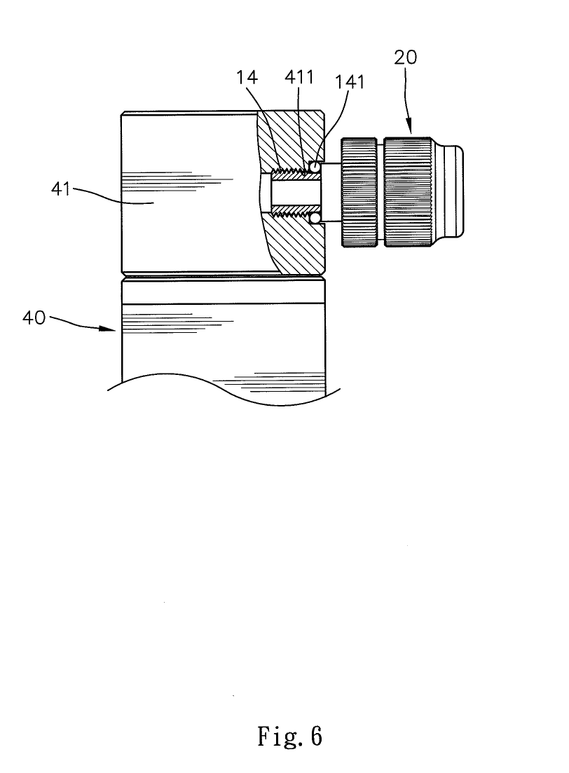

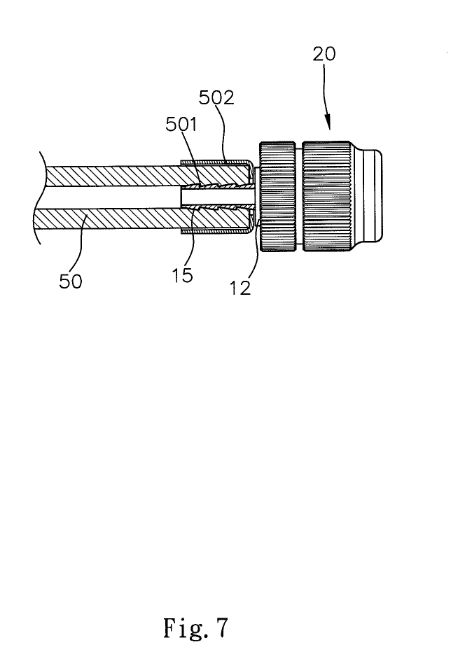

Referring to FIG. 6, the hose 12 includes a threaded end 14 so as to be threadedly connected with the reception hole 411 in the head part 41 of the tire pump 40. A washer 141 is used to seal the connection. An alternate way is disclosed in FIG. 7, wherein the hose 12 includes an engagement portion 15 to engage with a connection end 501 of a flexible hose 50 for the tire pump 40. A rigid restriction member 502 is mounted around the connection end 501 to keep the connection in place.

by using the sealing ring 30 in the groove 101 and the inner circular periphery 214 of the casing 21, the sealing device of the present invention provides reliable sealing function between the valve plug seat 10 and the tire valve.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An inflation nozzle of a tire pump having air sealing function, comprising:
a casing including first threads in a first end thereof to engage with a valve of a tire, second threads on a second end thereof and an inner circular periphery;
a valve plug seat including a head portion at a front end close to the first end of the casing, a groove defined annularly on an outer periphery thereof and a flange formed beside the groove, the valve plug seat connecting with a hose at a rear end thereof, the head portion inserted into the casing from a second end of the casing, a sealing ring disposed in the groove;
a valve plug disposed in the assembled head portion and the casing to connect with the valve of the tire; and
a locking ring having an opening and the hose extending through the opening, the locking ring including third threads which are threadedly connected with the second threads;
wherein the head portion is enclosed between the casing and the locking ring and the sealing ring is pressed against the inner circular periphery of the casing.

2. The inflation nozzle as claimed in claim 1, wherein the valve plug is a tubular member and received in the head portion.

3. The inflation nozzle as claimed in claim 2, wherein the valve plug includes a core member located at a center thereof.

4. The inflation nozzle as claimed in claim 1, wherein the inner circular periphery of the casing has a length which is longer than a sum of a length of the head portion of the valve plug seat and a width of the groove, such that the casing covers the groove and is connected to the locking ring.

5. The inflation nozzle as claimed in claim 1, wherein a radial width of the sealing ring is larger than a depth of the groove.

6. The inflation nozzle as claimed in claim 1, wherein the second threads on the casing are defined on an outer periphery of the casing.

7. The inflation nozzle as claimed in claim 1, wherein a groove is defined in an inner periphery of the first end of the casing and located beside the first threads.

8. The inflation nozzle as claimed in claim 7, wherein a valve plug is engaged with the groove in the first end of the casing and the valve plug is an O-ring.

9. The inflation nozzle as claimed in claim 1, wherein the third threads of the locking ring are defined in an inner periphery thereof.
